(19) United States
(12) Patent Application Publication
(10) Pub. No.: US 2025/0113328 A1
(43) Pub. Date: Apr. 3, 2025

(54) SIDELINK POSITIONING REFERENCE SIGNAL MEASUREMENT BASED ON A PLURALITY OF MEASUREMENT SAMPLES

(71) Applicant: Nokia Technologies Oy, Espoo (FI)

(72) Inventors: Hyun-Su CHA, Naperville, IL (US); Torsten WILDSCHEK, Gloucester (GB); Gilsoo LEE, Naperville, IL (US)

(21) Appl. No.: 18/829,056

(22) Filed: Sep. 9, 2024

Related U.S. Application Data
(60) Provisional application No. 63/586,477, filed on Sep. 29, 2023.

(51) Int. Cl. H04W 64/00; H04L 5/00; H04W 24/10; H04W 72/25; H04W 92/18

(52) U.S. Cl. CPC H04W 64/00; H04L 5/0051; H04W 24/10; H04W 72/25; H04W 92/18

(57) ABSTRACT

The present disclosure relates to a sidelink (SL) positioning measurement based on a plurality of measurement samples. In particular, a location server requests a receiving (RX) device to report SL positioning measurement that has been made from a plurality of measurement samples. The RX UE requests a transmitting (TX) UE to transmit a plurality of SL positioning reference signals (PRSs) through a plurality of SL PRS resources so that the RX UE can obtain multiple SL positioning measurement samples. In this way, it can improve SL positioning performance. The solution allows for high accuracy measurements and hence enables high accuracy SL positioning.

### CROSS-REFERENCE TO RELATED APPLICATION

This application claims priority from, and the benefit of, U.S. Provisional Application No. 63/586,477, filed Sep. 29, 2023, the contents of which are hereby incorporated by reference in their entirety.

### FIELDS

Various example embodiments of the present disclosure generally relate to the field of telecommunication and in particular, to methods, devices, apparatuses and computer readable storage medium for a sidelink (SL) positioning measurement based on a plurality of measurement samples.

### BACKGROUND

Location-awareness is a fundamental aspect of wireless communication networks and will enable a myriad of location-enabled services in different applications. The integration and utilization of location information in day-to-day applications will grow significantly as the technology's accuracy evolves. Many positioning technologies that depend on techniques such time of arrival (TOA), time difference of arrival (TDOA) and angle of arrival (AOA) require light-of-sight (LOS) propagation between a reference point (such as a network device) and a mobile device to be positioned. In some situations, user equipment (UE) may facilitate positioning a device. Therefore, it is worth studying on SL (SL) positioning.

### SUMMARY

In a first aspect of the present disclosure, there is provided a first device. The first device comprises at least one processor; and at least one memory storing instructions that, when executed by the at least one processor, cause the first device to: receive, from a second device, a first request for a sidelink positioning measurement that is based on a plurality of sidelink positioning measurement samples or a plurality of sidelink positioning reference signal resources; transmit, to a third device, a second request for a plurality of sidelink positioning reference signals transmitted on the plurality of sidelink positioning reference signal resources that is used to combine the plurality of sidelink positioning measurement sample; obtain the plurality of sidelink positioning measurement samples based on the plurality of sidelink positioning reference signals received from the third device; and determine the sidelink positioning measurement based on the plurality of sidelink positioning measurement samples.

In a second aspect of the present disclosure, there is provided a second device. The second device comprises at least one processor; and at least one memory storing instructions that, when executed by the at least one processor, cause the second device to: transmit, to a first device, a first request for a sidelink positioning measurement that is based on a plurality of sidelink positioning measurement samples or a plurality of sidelink positioning reference signal resources; and receive, from the first device, a measurement report indicating the sidelink positioning measurement.

In a third aspect of the present disclosure, there is provided a third device. The third device comprises at least one processor; and at least one memory storing instructions that, when executed by the at least one processor, cause the third device to: receive, from a first device, a second request for a plurality of sidelink positioning reference signals transmitted on a plurality of sidelink positioning reference signal resources that is used to combine a plurality of sidelink positioning measurement samples; and transmit, to the first device, the plurality of sidelink positioning reference signals through the plurality of sidelink positioning reference signal resources.

In a fourth aspect of the present disclosure, there is provided a method. The method comprises: receiving, from a second device, a first request for a sidelink positioning measurement that is based on a plurality of sidelink positioning measurement samples or a plurality of sidelink positioning reference signal resources; transmitting, to a third device, a second request for a plurality of sidelink positioning reference signals transmitted on the plurality of sidelink positioning reference signal resources that is used to combine the plurality of sidelink positioning measurement sample; obtaining the plurality of sidelink positioning measurement samples based on the plurality of sidelink positioning reference signals received from the third device; and determining the sidelink positioning measurement based on the plurality of sidelink positioning measurement samples.

In a fifth aspect of the present disclosure, there is provided a method. The method comprises: transmitting, to a first device, a first request for a sidelink positioning measurement that is based on a plurality of sidelink positioning measurement samples or a plurality of sidelink positioning reference signal resources; and receiving, from the first device, a measurement report indicating the sidelink positioning measurement.

In a sixth aspect of the present disclosure, there is provided a method. The method comprises: receiving, from a first device, a second request for a plurality of sidelink positioning reference signals transmitted on a plurality of sidelink positioning reference signal resources that is used to combine a plurality of sidelink positioning measurement samples; and transmitting, to the first device, the plurality of sidelink positioning reference signals through the plurality of sidelink positioning reference signal resources.

In a seventh aspect of the present disclosure, there is provided a computer readable medium. The computer readable medium comprises instructions stored thereon for causing an apparatus to perform at least the method according to the fourth aspect.

In an eighth aspect of the present disclosure, there is provided a computer readable medium. The computer readable medium comprises instructions stored thereon for causing an apparatus to perform at least the method according to the fifth aspect.

In a ninth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for a SL positioning measurement based on a plurality of measurement samples according to example embodiments of the present disclosure;

FIG. 3 illustrates a schematic diagram of transmissions of SL control information according to example embodiments of the present disclosure;

FIG. 4 illustrates a flowchart of a method implemented at a receiving device according to some example embodiments of the present disclosure;

FIG. 5 illustrates a flowchart of a method implemented at a server device according to some example embodiments of the present disclosure;

FIG. 6 illustrates a flowchart of a method implemented at a transmitting device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (cNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “target device/target UE” may refer to a device to be positioned. The term “anchor device/anchor UE” may refer to a device supporting positioning of the target device. For example, the anchor device may transmit and/or receive reference signal(s) for positioning over SL interface (such as, PC5 interface). The anchor device may also provide positioning related information. Functions of the anchor UE (i.e., anchor node) may be similar to uplink/downlink (UL/DL) based positioning, where gNBs serving as anchors transmit/receive reference signals to/from target UEs for positioning.

The term “SL positioning” used herein may prefer to positioning terminal device using reference signals transmitted over SL, i.e., PC5 interface, to obtain absolute position, relative position, or ranging information. The term “ranging” used herein may refer to a determination of the distance and/or the direction between a terminal device and another entity, e.g., anchor UE. The term “sidelink (SL) positioning reference signal (PRS)” used herein may refer to a reference signal transmitted over SL for positioning purposes. The term “SL PRS configuration” used herein may refer to a set of configured parameters of SL PRS, such as time-frequency resources including its bandwidth and periodicity, and direction-related parameters (e.g., beam direction, beam width, and number of beams). SL PRS (pre)configuration may also refer to (pre-)configured parameters of SL PRS such as transmit power. Further, the SL PRS configuration in coverage or partial coverage may be determined by the network (e.g., by location management function (LMF) or gNB), and out-of-coverage may be pre-configured and/or determined by UEs autonomously. SL synchronization consideration during anchor UE selection may also involve a roadside unit (RSU) where a UE-type or gNB-type stationary infrastructure entity supports vehicle-to-everything V2X applications. Absolute positioning may refer to estimating the UE's position in 2D/3D geographic coordinates (e.g., latitude, longitude, elevation) within a coordinate system. Additionally, relative positioning may refer to estimation of position relatively to other network elements or relatively to other UEs. The term “measurement sample” used herein may refer to a result of one measurement. For example, the RX UE may receive multiple sidelink (SL) positioning reference signals (PRSs) from multiple sidelink positioning reference signal resources. From each SL PRS resource, the RX UE obtains an SL positioning measurement such as an SL reference signal time difference (RSTD) measurement, which corresponds to a single SL RSTD measurement sample. From the multiple SL PRS resources, the Rx UE can obtain multiple SL RSTD measurement samples. The RX UE can combine the multiple SL RSTD measurement samples if the multiple SL PRSs from the multiple SL PRS resources are transmitted by the same antenna port and the same Tx beam from the TX UE. The term “antenna reference point (ARP)” may refer to a location of this phase center is represented by a mean constant offset from the physical point on an antenna. The ARP can be used as a fixed vertical reference. One ARP may be corresponding to an antenna panel or an antenna. The ARP can be further differentiated as a transmission ARP or a reception ARP. The term “SL PRS resource” used herein may refer to a time-frequency resource within a slot of a dedicated SL PRS resource pool that is used for SL PRS transmission. Characteristics associated with a SL PRS resource may include at least: SL PRS resource ID, SL PRS comb offset and associated SL PRS comb size (N), SL PRS starting symbol and number of SL PRS symbols (M), SL PRS frequency domain allocation.

In Uu positioning a DL PRS resource identity (ID) is unique within a DL PRS resource set and therefore when a UE reports a DL positioning measurement it can report the measurement associated with the DL PRS resource ID even if it uses multiple samples of that DL PRS resource. For example, periodic and semi-persistent reference signals (RSs) are periodic with a specific periodicity. For example, if a periodic channel state information (CSI)-RS resource or PRS resource is configured with 10 slots of periodicity, the UE perform measurements for every 10 slots. It may obtain multiple measurement samples, but the UE may report an averaged measurement.

For the reference signal (RS) measurements, the UE may perform measurement multiple times for a periodic or semi-persistent RS resource to guarantee measurement accuracy. For example, if a specific occasion of a PRS resource or a CSI-RS (resource is in deep fading, the UE may not be able to obtain a proper measurement. Thus, typically, the UE measures multiple samples and average the obtained samples to determine a specific measurement to be reported. The detailed behavior of averaging is up to the implementation. It might be questionable how many samples the UE needs to obtain.

SL positioning is based on the transmissions of SL PRS by multiple anchor UEs to be received by a target UE in e.g. SL TDOA approaches or SL PRS exchange between the anchor(s) and target UEs in e.g. SL (multi-)RTT approach to enable localization of the target UE and/or ranging of target UE with respect to a reference UE (e.g. anchor UE) within precise latency and accuracy requirements of the corresponding SL positioning.

In the scenario of SL positioning, a SL PRS resource may be identified by a SL PRS resource ID that is unique within a slot of a dedicated SL PRS resource pool. For SL-PRS transmission, it proposes (1) SL-PRS transmissions with periodic reservation: SL-PRS transmissions which are being reserved with a similar mechanism as the SL periodic resource reservation for another TB in SL communication; and (s) SL-PRS transmissions without periodic reservation: SL-PRS transmissions in which the SL-PRS is transmitted at least once without periodic reservation, with a similar mechanism as in SL communication with SL resource without periodic reservation.

However, the SL PRS resource is unique only within a slot, so periodic reservation does not guarantee a periodic transmission of a specific SL PRS. The UE cannot perform measurement averaging obtained from multiple SL PRS resources even if they are transmitted by the periodic reservation. In addition, the RX UE cannot average the SL positioning measurements across SL PRS resources even though they share the same ID, as the UE cannot assume these SL PRS resources are transmitted from the same antenna port, RF chain, and/or the same transmission beams.

In a solution, it proposes measurement combining indicator to support the RX UE, but it is limited from the following perspectives. For example, the RX UE needs to select whether to combine the multiple SL PRS resources although they can be combinable. For example, in case of a UE RX-TX time difference measurement, multiple received SL PRSs can be associated with a single TX SL PRS. In another example, if the RX UE has moved while receiving multiple combinable SL PRSs, the RX UE cannot combine the SL PRSs. Further, the location management function (LMF) or server UE cannot be aware of whether the RX UE obtained multiple or single measurement samples. The measurement indicator can be indicated to the UE, but the RX UE still can decide whether to combine the multiple measurement samples or not depending on RX antenna reference point (ARP) ID or due to other reasons such as channel condition. Thus, a solution on a SL positioning measurement based on a plurality of measurement samples is needed.

According to embodiments of the present disclosure, a location server requests an RX device to report SL positioning measurement that has been made from a plurality of measurement samples. The RX UE requests a TX UE to transmit a plurality of SL PRSs through a plurality of SL PRS resources so that the RX UE can obtain multiple SL positioning measurement samples. In this way, it can improve SL positioning performance. The solution allows for high accuracy measurements and hence enables high accuracy SL positioning.

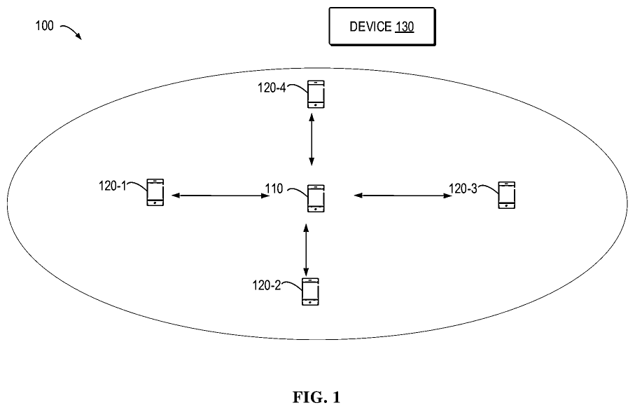

FIG. 1 illustrates an example communication environment 100 in which example embodiments of the present disclosure can be implemented. In the communication environment 100, there is a device 110. The device 110 may be a for example, a mobile phone, or a vehicle. The communication environment 100 includes a set of devices 120-1, 120-2, . . . , and 120-N (collectively referred to as “device 120”), where N may be an integer number. It is noted that the set of devices 120 may include any proper number of terminal devices. The communication environment 100 also includes a device 130 which can be a server terminal device or a network node (for example, a location management function (LMF) node). The server terminal device may have a part or all of functionalities of the LMF.

In the following, for the purpose of illustration, some example embodiments are described with the device 110 operating as a target device and the device 120 operating as an anchor device. However, in some example embodiments, operations described in connection with a target device may be implemented at an anchor device, and operations described in connection with an anchor device may be implemented at a target device. The device 110 may be referred to as “target device 110” and the terminal device(s) 120 may be referred to as “anchor device(s) 120” hereinafter.

In some example embodiments, a link between the target device 110 and the anchor device 120 is referred to as a SL (SL), and a link among the anchor devices is also referred to as SL. In some example embodiments, the anchor device 120 is a transmitting (TX) device (or a transmitter) and the target device 110 is a receiving (RX) device (or a receiver). In some other example embodiments, the target device 110 is a TX device (or a transmitter) and the anchor device 120 is a RX device (or a receiver). It is to be understood that the number of devices and their connections shown in FIG. 1 are only for the purpose of illustration without suggesting any limitation. The communication environment 100 may include any suitable number of devices configured to implementing example embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

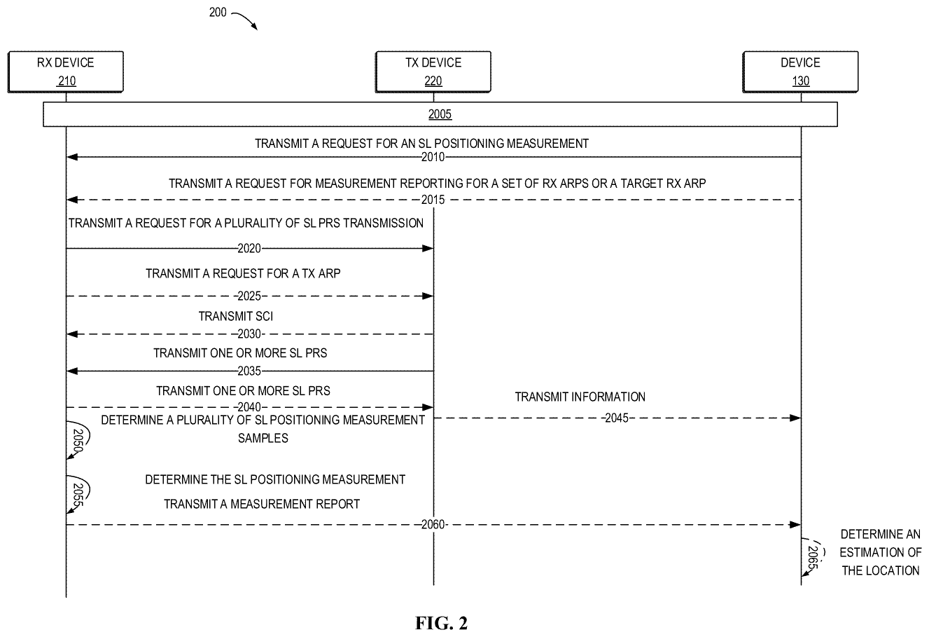

Example embodiments of the present disclosure will be described in detail below with reference to the accompanying drawings. Reference is now made to FIG. 2, which illustrates a signaling flow 200 for the reference signal transmission alignment according to some example embodiments of the present disclosure. The signaling flow 200 may involve an RX device 210, a TX device 220 and the device 130. In some example embodiments, for example, in a DL-like TDOA scenario, the RX device 210 may be the target device 110 and the TX device 220 may be the anchor device 120. In some other example embodiments, for example, in a UL-link TDOA scenario, the RX device 210 may be the anchor device 120 and the TX device 220 may be the target device 110. Alternatively, in multi-round trip time (RTT) scenario, both the target device 110 and the anchor device 120 can act as the RX device 210 and the TX device 220.

The device 130 may involve (2005) an anchor device (for example, the anchor device 120-1) and a target device (for example, the target device 110) into an SL positioning procedure with a positioning technique. In some example embodiments, the positioning technique may include a DL-like TDOA where the anchor device transmits the reference signals to the target device. In some other example embodiments, the positioning technique may include a UL-like TDOA where the target device transmits the reference signals to the anchor device. Alternatively, the positioning technique may include a Multi-RTT where the target device and the anchor device transmit the reference signals to each other and receive the reference signals from each other.

In some example embodiments, the anchor device may report its SL positioning capabilities to the device 130. Alternatively, or in addition, the target device may also report its SL positioning capabilities to the device 130. The SL positioning capabilities may include one or more of: an SL positioning technique, a measurement type, or the number of TX/RX ARPs with their relative location.

The device 130 transmits (2010), to the RX device 210, a request (referred to as “first request” hereinafter) for a SL positioning measurement that is based on a plurality of SL positioning measurement samples or a plurality of SL PRS resources. In other words, the RX device 210 receives the first request from the device 130. For example, the first request may be used to request the RX device to report SL positioning measurement that has been made from multiple measurement samples, for example, at least more than N (>0) sample(s). In some example embodiments, the first request may further include a specific number of SL positioning measurement samples, for example, N. In some example embodiments, if the UL-like TDOA is applied, the first request is transmitted to the anchor device which is the RX device 120. Alternatively, if the DL-like TDOA is applied, the first request is transmitted to the target device which is the RX device 120. In some other example embodiments, if the multi-RTT is applied, the first request is transmitted to the anchor device and the target device.

In some example embodiments, the device 130 may transmit (2015), to the RX device 210, a request (referred to as “third request”) for a set of SL positioning measurements associated with a set of RX ARP at the RX device 210. In other words, the RX device 210 may receive the third request from the device 130. For example, the third request may indicate the RX device 210 to report M (>0) SL positioning measurements associated with M (>0) RX ARPs (such as each SL positioning measurement corresponds to each RX ARP), where M is an integer number. For example, the set of SL positioning measurements may include one or more of: a propagation time, a RSTD (Reference Signal Time Difference), a UE Rx-Tx time difference measurement, a RTOA (Relative Time Of Arrival) measurement, a RSCP (Reference Signal Carrier Phase) measurement, a RSCPD (Reference Signal Carrier Phase Difference) measurement, a RSRP (Reference Signal Received Power) measurement, a RSRPP (Reference Signal Received Power per signal Path). Example of these measurements are defined in 3GPP technical specification (TS) 38.215.

Alternatively, the device 130 may transmit (2015), to the RX device 210, a request (referred to as “fourth request”) for a set of SL positioning measurements for a target receiving antenna reference point at the RX device 210. In other words, the RX device 210 may receive the fourth request from the device 130. For example, the fourth request may indicate the RX device 210 to report a SL positioning measurement for a specific RX ARP #ID. In some example embodiments, identity information of the RX APR(s) at the RX device 210 may be preconfigured.

In another example embodiment, the device 130 may transmit, to the RX device 210, a request (referred to as “sixth” request) that indicates the RX device 210 to obtain the specific number of sidelink positioning measurement samples. In other words, the RX device 210 may receive the sixth request from the device 130. In some example embodiments, the sixth request may be included in the first request, for example, as an indication in the first request.

The RX device 210 transmits (2020), to the TX device 220, a request (referred to as “second request”) for a plurality of SL PRSs transmitted on the plurality of PRS resources that can be used to combine the plurality of SL positioning measurement samples. In other words, the TX device 220 receives the second request from the RX device 210. That is, the second request may indicate a plurality of SL PRS transmissions. In some example embodiments, the second request may indicate the number of measurement samples (i.e., the number of SL PRS transmissions) that the RX device 210 needs. In this way, the RX device 210 could obtain multiple SL positioning measurement samples, thereby improving positioning accuracy.

In some example embodiments, the RX device 210 may transmit (2025), to the TX device 220, a request (referred to as “fifth request”) of TX ARP(s). In other words, the TX device 220 may receive the fifth request from the RX device 210. For example, the fifth request may indicate a target ARP. By way of example, the fifth request may include an ID of the target ARP. Alternatively, the fifth request may indicate a set of TX ARP for the plurality of SL PRSs at the TX device 220. For example, the fifth request may include IDs of the set of TX ARP. In this way, it can achieve an efficient use of multiple SL PRS resources.

The TX device 220 may transmit (2030) SL control information (SCI) to the RX device 210. In other words, the RX device 210 may receive the SCI from the TX 220. In some example embodiments, the SCI may indicate that a SL PRS scheduled by the SCI is associated with a previous SL PRS resource and a TX ARP. For example, the SCI may indicate that the SL PRS transmitted in the current slot is a repeated or periodic transmission of the previously transmitted SL PRS resource(s). In some example embodiments, for multi-RRT scenario, since both the anchor device and the target device can act as the TX device 220, both the anchor device and the target device may transmit SCI to indicate whether the current SL PRS transmission is a repetition of the previous SL PRS resource or not.

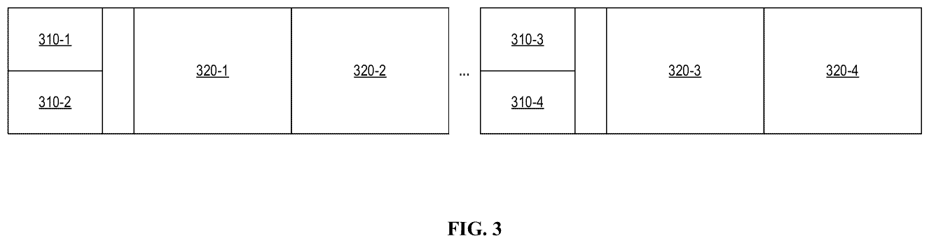

By way of example, the most recent N SCIs indicate that the transmitted SL PRS resources are the repetition of a SL PRS resource #1, where the SL PRS resource #1 was scheduled/configured from the first SCI. For example, as shown in FIG. 3, the TX device 220 may transmit, to the RX device 210, SCI 310-1 that schedules a SL PRS on a SL PRS resources 320-1. The TX device 220 may also transmit, to the RX device 210, SCI 310-2 that schedules a SL PRS on a SL PRS resources 320-2, SCI 310-3 that schedules a SL PRS on a SL PRS resources 320-3 and, SCI 310-4 that schedules a SL PRS on a SL PRS resources 320-4. In this case, the SCI 310-2, 310-3 and 310-4 may indicate that the SL PRS resources 320-2, 310-2 and 320-4 are the repetitions of the SL PRS resource 310-1, respectively. It is noted that the number of SCI and the SL PRS resources shown in FIG. 3 are only examples not limitations.

In some other example embodiments, the SCI may indicate SL PRS resource identity information for a previous SL PRS. Alternatively, the SCI may indicate a timestamp for the previous SL PRS. The SCI may also indicate TX APR information for the previous SL PRS.

The TX device 220 transmits (2035) one or more SL PRSs to the RX device 210. In other words, the RX device 210 receives the one or more SL PRSs from the TX device 220. For example, the TX device 220 may transmit the SL PRSs on the SL PRS resources 320-1, 320-2, 320-3 and 320-4. In some example embodiments, the TX device 220 may transmit the associated one or more SL PRSs using at least one of: a same radio frequency chain, a same beam, a same transmission power, or a same antenna port. For example, the SL PRSs on the SL PRS resources 320-1, 320-2, 320-3 and 320-4 may be transmitted using one or more of: the same radio frequency chain, the same beam, the same transmission power, or the same antenna port of the device 220. In this case, in some example embodiments, the RX device 210 may determine, by an association indicated by the SCI, the plurality of SL PRSs is transmitted by the third device using at least one of: the same radio frequency chain, the same beam, the same transmission power, or the same antenna port of the device 220. In some example embodiments, for example, the Multi-RTT, the RX device 210 may transmit (2040) a SCI and a SL PRS that is scheduled by the SCI to the TX device 220.

In some example embodiments, the TX device 220 may transmit (2045), to the device 130, information that indicates one or more of: TX ARP information for the plurality of SL PRSs or location information of the TX ARP used for the SL PRS transmission. In other words, the device 130 may receive the TX ARP information used for SL PRS transmission and the location information on TX ARP from the TX device 220.

The RX device 210 determines (2050) a plurality of SL positioning measurement samples based on the plurality of SL PRSs that is received from the TX device 220. For example, the RX device 210 may measure reference signal received power (RSRP) of the plurality of SL PRSs. By way of example, the RX device 210 may measure the RSRP on the SL PRS transmitted on the SL PRS resource 320-1. The RX device 210 may also measure the RSRP on the SL PRSs transmitted on the SL PRS resources 320-2, 320-3 and 320-4. Alternatively, the RX device 210 may measure a plurality of SL relative time of arrival (RTOA) based on the plurality of SL PRSs. It is noted that the RX device 210 may obtain any proper metrics based on the plurality of SL PRSs that can be used for positioning. In some example embodiments, for multi-RRT scenario, both the target device and the anchor device may transmit SL PRS(s) and perform the SL positioning measurements. By way of example, the RX device 210 may combine multiple SL RSTD measurement samples if the multiple SL PRSs from the multiple SL PRS resources are transmitted by the same antenna port and the same Tx beam from the TX device 210.

The RX device 210 determines (2055) the SL positioning measurement based on the plurality of SL positioning measurement samples (obtained at 2050). For example, the RX device 210 may determine whether to use all the repeated SL PRS transmissions for the SL positioning measurement. Only as an example, the RX device 210 may determine whether to combine all the SL PRS transmissions on the SL PRS resources 320-2, 320-3 and 320-4 which are the repetitions of the SL PRS transmission on the SL PRS resource 320-1.

In some example embodiments, the RX device 210 may determine how many measurement samples used to determine the SL positioning measurement. For example, in case the RX device 210 has moved between the same PRS transmission with multiple repetitions, the RX device 210 may determine to report an SL positioning measurement based on the single measurement sample. Note that the device 130 uses the reported measurement and a specific coordinate of the RX device, so the RX device 210 may not mix up multiple measurement samples if they have been made at different locations. In some other example embodiments, the RX device 210 may determine how many measurement samples used to determine the SL positioning measurement based on the first request, for example, based on the specific number of SL positioning measurement samples indicated in the first request.

The RX device 210 may transmit (2060) a measurement report indicating the SL positioning measurement to the device 130. In other words, the device 130 may receive the measurement report indicating the SL positioning measurement from the RX device 210. In some example embodiments, if the third request for the set of SL positioning measurements associated with the set of RX ARP is received, the measurement report may include the set of SL positioning measurements. Alternatively, if the fourth request for the set of SL positioning measurements for the target RX ARP is received, the measurement report may include the set of SL positioning measurements.

In some example embodiments, the measurement report may also include one or more of: a SL positioning type related to the SL positioning measurement, identity information associated with the plurality of SL PRS resources, ARP information associated with the plurality of SL PRSs, the actual number of the SL positioning measurement samples used to determine the SL positioning measurement, or the number of the at least one PRS for the SL positioning measurement. For example, the RX device 210 may provide the device 130 with {SL positioning measurement(s), SL PRS resource #ID, RX ARP information, the number of measurement samples} in the measurement report. By way of example, the RX device 210 may then send {SL RTOA, (SL PRS resource #1, RX ARP #1), (SL PRS resource #2, RX ARP #1), (SL PRS resource #3, RX ARP #1)} in the measurement report to the device 130. In some example embodiments, the identity information of SL PRS resources may be configured by a network device, for example, the device 130.

In some example embodiments, for multi-RRT scenario, the RX device 210 may report a SL UE RX-TX time difference measurement, the number of used measurement samples, its associated two SL PRS resource IDs used for transmission and reception, RX ARP ID and/or TX ARP ID. For example, even if the RX device 210 uses the same ARP for the SL PRS transmission and reception, the RX device 210 may still be able to report a UE RX-TX time difference measurement per ARP. For the same SL PRS resource transmitted from the TX UE, the RX device 210 can report a different number of measurement samples depending on ARP. For a SL PRS reception of the same SL PRS resource, the RX UE may report the followings: (1) a UE RX-TX time difference measurement #1, an RX ARP ID #1, an SL PRS resource #ID transmitted to the TX device 220 (from this RX device), the number of used measurement samples, time stamp #1; (2) a UE RX-TX time difference measurement #2, an RX ARP ID #1, an SL PRS resource #ID transmitted to the TX device 220 (from this RX device), the number of used measurement samples, time stamp #2.

The device 130 may determine (2065) an estimation of location of the target device based at least on the SL positioning measurement. For example, if the device 130 receives the information on (SL positioning measurement(s), SL PRS resource #ID, R×ARP information, the number of measurement samples), the device 130 may determine which measurements to be used to estimate the location of the target device at least based on the measurement samples. For example, if a number of devices (for example, N devices) report SL positioning measurements, the device 130 may select M devices (M<N) and select M SL positioning measurements if M SL positioning measurements are made based on enough multiple measurement samples. For example, the anchor devices 120-1, 120-2 and 120-3 may have reported SL RTOA measurements to the device 130. If the SL RTOA measurements from the anchor devices 120-1 and 120-2 are made based on 4 samples, but the SL RTOA measurement from the anchor device 120-3 is made based on a single sample, the device 130 may select the anchor devices 120-1 and 120-2 and their reported SL RTOA measurements.

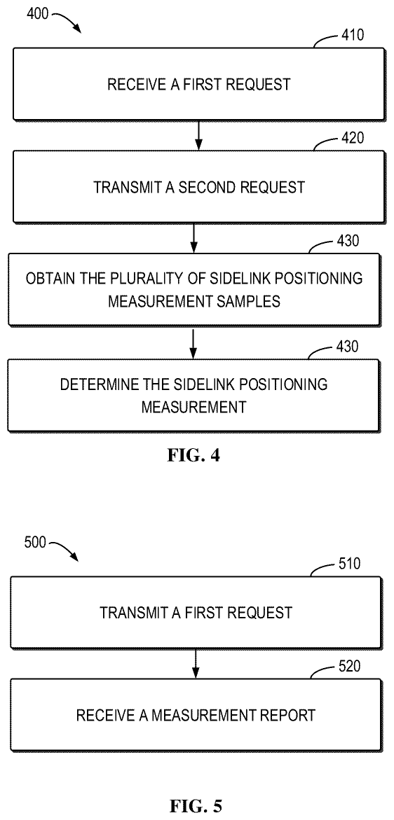

FIG. 4 shows a flowchart of an example method 400 implemented at a first device which is an RX device in accordance with some example embodiments of the present disclosure.

At block 410, the first device receives, from a second device, a first request for a sidelink positioning measurement that is based on a plurality of sidelink positioning measurement samples or a plurality of sidelink positioning reference signal resources. In the present disclosure, the sidelink positioning measurements at least include a propagation time, a RSTD (Reference Signal Time Difference), a UE Rx-Tx time difference measurement, a RTOA (Relative Time Of Arrival) measurement, a RSCP (Reference Signal Carrier Phase) measurement, a RSCPD (Reference Signal Carrier Phase Difference) measurement, a RSRP (Reference Signal Received Power) measurement, a RSRPP (Reference Signal Received Power per signal Path). Example of these measurements are defined in 3GPP TS 38.215.

At block 420, the first device transmits, to a third device, a second request for a plurality of sidelink positioning reference signals transmitted on the plurality of sidelink positioning reference signal resources that is used to combine the plurality of sidelink positioning measurement sample.

At block 430, the first device obtains the plurality of sidelink positioning measurement samples based on the plurality of sidelink positioning reference signals received from the third device.

At block 440, the first device performs the sidelink positioning measurement based on the plurality of sidelink positioning measurement samples.

In some example embodiments, the method 400 further comprises: transmitting, to the second device, a measurement report indicating the sidelink positioning measurement.

In some example embodiments, the method 400 further comprises: receiving, form the second device, a third request for a set of sidelink positioning measurements associated with a set of receiving antenna reference points at the first device; and transmitting, to the second device, the measurement report comprising the set of sidelink positioning measurements.

In some example embodiments, the method 400 further comprises: receiving, from the second device, a fourth request for a set of sidelink positioning measurements for a receiving antenna reference point at the first device; and transmitting, to the second device, the measurement report comprising the set of sidelink positioning measurements.

In some example embodiments, the method 400 further comprises: transmitting, to the third device, a fifth request indicating a transmitting antenna reference point or a set of transmitting antenna reference points for the plurality of sidelink positioning reference signals at the third device.

In some example embodiments, the method 400 further comprises: receiving, from the third device, sidelink control information indicating that a sidelink positioning reference signal scheduled by the sidelink control information is associated with a previous sidelink positioning reference signal resource and a transmitting antenna reference point.

In some example embodiments, the method 400 further comprises: receiving, from the third device, sidelink control information indicating at least one of: sidelinking positioning reference signal resource identity information for a previous sidelink positioning reference signal, a timestamp for the previous sidelink positioning reference signal, or transmitting antenna reference point information for the previous sidelink positioning reference signal.

In some example embodiments, the method 400 further comprises: determining the plurality of sidelink positioning reference signals is transmitted by the third device using at least one of: a same radio frequency chain, a same beam, a same transmission power, or a same antenna port, based on an association indicated by the sidelink control information.

In some example embodiments, the method 400 further comprises: determining the number of the at least one sidelink positioning reference signal that is used for the sidelink positioning measurement.

In some example embodiments, the measurement report further comprises at least one of a sidelink positioning type related to the sidelink positioning measurement, identity information associated with the plurality of sidelink positioning reference signal resource, antenna reference point information associated with the plurality of sidelink positioning reference signal, the actual number of the sidelink positioning measurement samples used to determine the sidelink positioning measurement, or the number of the at least one sidelink positioning reference signal.

In some example embodiments, this first request further comprises a specific number of sidelink positioning measurement samples.

In some example embodiments, the first device comprises a receiving terminal device which is an anchor terminal device or a target terminal device, the second device comprises a transmitting terminal device which is the target terminal device or the anchor terminal device, and the third device comprises a network device or a terminal device.

FIG. 5 shows a flowchart of an example method 500 implemented at a second device which is a server UE or a LMF in accordance with some example embodiments of the present disclosure.

At block 510, the second device transmits, to a first device, a first request for a sidelink positioning measurement that is based on a plurality of sidelink positioning measurement samples or a plurality of sidelink positioning reference signal resources.

At block 520, the second device receives, from the first device, a measurement report indicating the sidelink positioning measurement.

In some example embodiments, the method 500 further comprises: transmitting, to the first device, a third request for a set of sidelink positioning measurements associated with a set of receiving antenna reference points at the first device; and receiving, from the first device, the measurement report comprising the set of sidelink positioning measurements.

In some example embodiments, the method 500 further comprises: transmitting, to the first device, a fourth request for a set of sidelink positioning measurements for a target receiving antenna reference point at the first device; and receiving, from the first device, the measurement report comprising the set of sidelink positioning measurements.

In some example embodiments, the method 500 further comprises: receiving, from the third device, information indicating at least one of: transmitting antenna reference point information for the plurality of sidelink positioning reference signals, or location information of a transmitting antenna reference point for the plurality of sidelink positioning reference signal.

In some example embodiments, the measurement report further comprises at least one of a sidelink positioning type related to the sidelink positioning measurement, identity information associated with the plurality of sidelink positioning reference signal resource, antenna reference point information associated with the plurality of sidelink positioning reference signals, the actual number of the sidelink positioning measurement samples used to determine the sidelink positioning measurement, or the number of the at least one sidelink positioning reference signal.

In some example embodiments, the method 500 further comprises: determining an estimation of location of a target device based at least on the sidelink positioning measurement, wherein the target device is the first device or the third device.

In some example embodiments, this first request further comprises a specific number of sidelink positioning measurement samples.

In some example embodiments, the method 500 further comprises: transmitting, to the first device, a sixth request that indicates the first device to obtain the specific number of sidelink positioning measurement samples.

In some example embodiments, the first device comprises a receiving terminal device which is an anchor terminal device or a target terminal device, the second device comprises a transmitting terminal device which is the target terminal device or the anchor terminal device, and the third device comprises a network device or a terminal device.

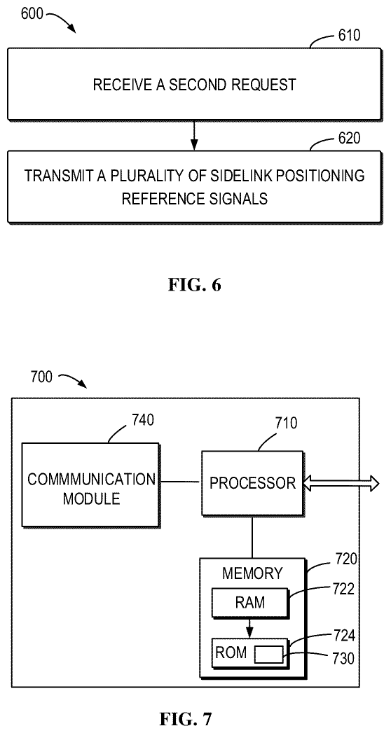

FIG. 6 shows a flowchart of an example method 600 implemented at a third device which is a TX device in accordance with some example embodiments of the present disclosure.

At block 610, the third device receives, from a first device, a second request for a plurality of sidelink positioning reference signals transmitted on a plurality of sidelink positioning reference signal resources that is used to combine a plurality of sidelink positioning measurement samples.

At block 620, the third device transmits, to the first device, the plurality of sidelink positioning reference signals through the plurality of sidelink positioning reference signal resources.

In some example embodiments, the method 600 further comprises: receiving, from the first device, a fifth request that indicating a target transmitting antenna reference point or a set of transmitting antenna reference points for the plurality of sidelink positioning reference signals at the third device.

In some example embodiments, the method 600 further comprises: transmitting, to the first device, sidelink control information indicating that a sidelink positioning reference signal scheduled by the sidelink control information is associated with a previous sidelink positioning reference signal resource and a transmitting antenna reference point.

In some example embodiments, the method 600 further comprises: transmitting, to the first device, sidelink control information indicating at least one of: sidelink positioning reference signal resource identity information for a previous sidelink positioning reference signal, a timestamp for the previous sidelink positioning reference signal, or transmitting antenna reference point information for the previous sidelink positioning reference signal.

In some example embodiments, the method 600 further comprises: transmitting the associated plurality of sidelink positioning reference signals using at least one of: a same radio frequency chain, a same beam, a same transmission power, or a same antenna port.

In some example embodiments, the method 600 further comprises: transmitting, to the first device, information indicating at least one of: transmitting antenna reference point information for the plurality of sidelink positioning reference signal, or locationing information of a transmitting antenna reference point for the plurality of sidelink positioning reference signal.

In some example embodiments, the first device comprises a receiving terminal device which is an anchor terminal device or a target terminal device, the second device comprises a transmitting terminal device which is the target terminal device or the anchor terminal device, and the third device comprises a network device or a terminal device.

In some example embodiments, a first apparatus capable of performing any of the method 400 (for example, the target device 110 or the anchor device 120 in FIG. 1) may comprise means for performing the respective operations of the method 400. The means may be implemented in any suitable form. For example, the means may be implemented in a circuitry or software module. The first apparatus may be implemented as or included in the target device 110 or the anchor device 120 in FIG. 1.

In some example embodiments, the first apparatus comprises means for receiving, from a second apparatus, a first request for a sidelink positioning measurement that is based on a plurality of sidelink positioning measurement samples or a plurality of sidelink positioning reference signal resources; means for transmitting, to a third apparatus, a second request for a plurality of sidelink positioning reference signals transmitted on the plurality of sidelink positioning reference signal resources that is used to combine the plurality of sidelink positioning measurement sample; means for obtaining the plurality of sidelink positioning measurement samples based on the plurality of sidelink positioning reference signals received from the third apparatus; and means for determining the sidelink positioning measurement based on the plurality of sidelink positioning measurement samples.

In some example embodiments, the first apparatus further comprises: means for transmitting, to the second apparatus, a measurement report indicating the sidelink positioning measurement.

In some example embodiments, the first apparatus further comprises: means for receiving, form the second apparatus, a third request for a set of sidelink positioning measurements associated with a set of receiving antenna reference points at the first apparatus; and means for transmitting, to the second apparatus, the measurement report comprising the set of sidelink positioning measurements.

In some example embodiments, the first apparatus further comprises: means for receiving, from the second apparatus, a fourth request for a set of sidelink positioning measurements for a receiving antenna reference point at the first apparatus; and means for transmitting, to the second apparatus, the measurement report comprising the set of sidelink positioning measurements.

In some example embodiments, the first apparatus further comprises: means for transmitting, to the third apparatus, a fifth request indicating a transmitting antenna reference point or a set of transmitting antenna reference points for the plurality of sidelink positioning reference signals at the third apparatus.

In some example embodiments, the first apparatus further comprises: means for receiving, from the third apparatus, sidelink control information indicating that a sidelink positioning reference signal scheduled by the sidelink control information is associated with a previous sidelink positioning reference signal resource and a transmitting antenna reference point.

In some example embodiments, the first apparatus further comprises: means for receiving, from the third apparatus, sidelink control information indicating at least one of: sidelink positioning reference signal resource identity information for a previous sidelink positioning reference signal, a timestamp for the previous sidelink positioning reference signal, or transmitting antenna reference point information for the previous sidelink positioning reference signal.

In some example embodiments, the first apparatus further comprises: means for determining the plurality of sidelink positioning reference signals is transmitted by the third apparatus using at least one of: a same radio frequency chain, a same beam, a same transmission power, or a same antenna port, based on an association indicated by the sidelink control information.

In some example embodiments, the first apparatus further comprises: means for determining the number of the at least one sidelink positioning reference signal that is used for the sidelink positioning measurement.

In some example embodiments, the measurement report further comprises at least one of a sidelink positioning type related to the sidelink positioning measurement, identity information associated with the plurality of sidelink positioning reference signal resource, antenna reference point information associated with the plurality of sidelink positioning reference signal, the actual number of the sidelink positioning measurement samples used to determine the sidelink positioning measurement, or the number of the at least one sidelink positioning reference signal.

In some example embodiments, this first request further comprises a specific number of sidelink positioning measurement samples.

In some example embodiments, the first apparatus comprises a receiving terminal device which is an anchor terminal device or a target terminal device, the second apparatus comprises a transmitting terminal device which is the target terminal device or the anchor terminal device, and the third apparatus comprises a network device or a terminal device.

In some example embodiments, the first apparatus further comprises means for performing other operations in some example embodiments of the method 400 or the target device 110 or the anchor device 120. In some example embodiments, the means comprises at least one processor; and at least one memory storing instructions that, when executed by the at least one processor, cause the performance of the first apparatus.

In some example embodiments, a second apparatus capable of performing any of the method 500 (for example, the device 130 in FIG. 1) may comprise means for performing the respective operations of the method 500. The means may be implemented in any suitable form. For example, the means may be implemented in a circuitry or software module. The second apparatus may be implemented as or included in the device 130 in FIG. 1.

In some example embodiments, the second apparatus comprises means for transmitting, to a first apparatus, a first request for a sidelink positioning measurement that is based on a plurality of sidelink positioning measurement samples or a plurality of sidelink positioning reference signal resources; and means for receiving, from the first apparatus, a measurement report indicating the sidelink positioning measurement.

In some example embodiments, the second apparatus further comprises: means for transmitting, to the first apparatus, a third request for a set of sidelink positioning measurements associated with a set of receiving antenna reference points at the first apparatus; and means for receiving, from the first apparatus, the measurement report comprising the set of sidelink positioning measurements.

In some example embodiments, the second apparatus further comprises: means for transmitting, to the first apparatus, a fourth request for a set of sidelink positioning measurements for a target receiving antenna reference point at the first apparatus; and means for receiving, from the first apparatus, the measurement report comprising the set of sidelink positioning measurements.

In some example embodiments, the second apparatus further comprises: means for receiving, from the third apparatus, information indicating at least one of: transmitting antenna reference point information for the plurality of sidelink positioning reference signals, or location information of a transmitting antenna reference point for the plurality of sidelink positioning reference signal.

In some example embodiments, the measurement report further comprises at least one of a sidelink positioning type related to the sidelink positioning measurement, identity information associated with the plurality of sidelink positioning reference signal resource, antenna reference point information associated with the plurality of sidelink positioning reference signals, the actual number of the sidelink positioning measurement samples used to determine the sidelink positioning measurement, or the number of the at least one sidelink positioning reference signal.

In some example embodiments, the second apparatus further comprises: means for determining an estimation of location of a target apparatus based at least on the sidelink positioning measurement, wherein the target apparatus is the first apparatus or the third apparatus.

In some example embodiments, this first request further comprises a specific number of sidelink positioning measurement samples.

In some example embodiments, the second apparatus further comprises: means for transmitting, to the first apparatus, a sixth request that indicates the first apparatus to obtain the specific number of sidelink positioning measurement samples.

In some example embodiments, the first device comprises a receiving terminal device which is an anchor terminal device or a target terminal device, the second device comprises a transmitting terminal device which is the target terminal device or the anchor terminal device, and the third device comprises a network device or a terminal device.

In some example embodiments, the second apparatus further comprises means for performing other operations in some example embodiments of the method 500 or the device 130. In some example embodiments, the means comprises at least one processor; and at least one memory storing instructions that, when executed by the at least one processor, cause the performance of the second apparatus.

In some example embodiments, a third apparatus capable of performing any of the method 600 (for example, the target device 110 or the anchor device 120 in FIG. 1) may comprise means for performing the respective operations of the method 600. The means may be implemented in any suitable form. For example, the means may be implemented in a circuitry or software module. The third apparatus may be implemented as or included in the target device 110 or the anchor device 120 in FIG. 1.

In some example embodiments, the third apparatus comprises means for receiving, from a first apparatus, a second request for a plurality of sidelink positioning reference signals transmitted on a plurality of sidelink positioning reference signal resources that is used to combine a plurality of sidelink positioning measurement samples; and means for transmitting, to the first apparatus, the plurality of sidelink positioning reference signals through the plurality of sidelink positioning reference signal resources.

In some example embodiments, the third apparatus further comprises: means for receiving, from the first apparatus, a fifth request that indicating a target transmitting antenna reference point or a set of transmitting antenna reference points for the plurality of sidelink positioning reference signals at the third apparatus.

In some example embodiments, the third apparatus further comprises: means for transmitting, to the first apparatus, sidelink control information indicating that a sidelink positioning reference signal scheduled by the sidelink control information is associated with a previous sidelink positioning reference signal resource and a transmitting antenna reference point.

In some example embodiments, the third apparatus further comprises: means for transmitting, to the first apparatus, sidelink control information indicating at least one of: sidelink positioning reference signal resource identity information for a previous sidelink positioning reference signal, a timestamp for the previous sidelink positioning reference signal, or transmitting antenna reference point information for the previous sidelink positioning reference signal.

In some example embodiments, the third apparatus further comprises: means for transmitting the associated plurality of sidelink positioning reference signals using at least one of: a same radio frequency chain, a same beam, a same transmission power, or a same antenna port.

In some example embodiments, the third apparatus further comprises: means for transmitting, to the first apparatus, information indicating at least one of: transmitting antenna reference point information for the plurality of sidelink positioning reference signal, or location information of a transmitting antenna reference point for the plurality of sidelink positioning reference signal.

In some example embodiments, the first device comprises a receiving terminal device which is an anchor terminal device or a target terminal device, the second device comprises a transmitting terminal device which is the target terminal device or the anchor terminal device, and the third device comprises a network device or a terminal device.

In some example embodiments, the third apparatus further comprises means for performing other operations in some example embodiments of the method 600 or the target device 110 or the anchor device 120. In some example embodiments, the means comprises at least one processor; and at least one memory storing instructions that, when executed by the at least one processor, cause the performance of the third apparatus.

FIG. 7 is a simplified block diagram of a device 700 that is suitable for implementing example embodiments of the present disclosure. The device 700 may be provided to implement a communication device, for example, the target device 110, the anchor device 120 or the device 130. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

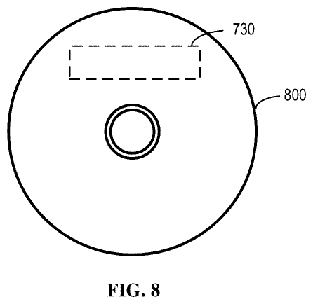

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device, comprising:
at least one processor; and
at least one memory storing instructions that, when executed by the at least one processor, cause the first device to:
receive, from a second device, a first request for a sidelink positioning measurement that is based on a plurality of sidelink positioning measurement samples or a plurality of sidelink positioning reference signal resources;
transmit, to a third device, a second request for a plurality of sidelink positioning reference signals transmitted on the plurality of sidelink positioning reference signal resources that is used to combine the plurality of sidelink positioning measurement sample;
obtain the plurality of sidelink positioning measurement samples based on the plurality of sidelink positioning reference signals received from the third device; and
determine the sidelink positioning measurement based on the plurality of sidelink positioning measurement samples.

2. The first device of claim 1, wherein the first device is caused to:
transmit, to the second device, a measurement report indicating the sidelink positioning measurement.

3. The first device of claim 1, wherein the first device is caused to:
receive, form the second device, a third request for a set of sidelink positioning measurements associated with a set of receiving antenna reference points at the first device; and
transmit, to the second device, the measurement report comprising the set of sidelink positioning measurements.

4. The first device of claim 1, wherein the first device is caused to:
receive, from the second device, a fourth request for a set of sidelink positioning measurements for a receiving antenna reference point at the first device; and
transmit, to the second device, the measurement report comprising the set of sidelink positioning measurements.

5. The first device of claim 1, wherein the first device is caused to:
transmit, to the third device, a fifth request indicating a transmitting antenna reference point or a set of transmitting antenna reference points for the plurality of sidelink positioning reference signals at the third device.

6. The first device of claim 1, wherein the first device is caused to:
receive, from the third device, sidelink control information indicating that a sidelink positioning reference signal scheduled by the sidelink control information is associated with a previous sidelink positioning reference signal resource and a transmitting antenna reference point.

7. The first device of claim 1, wherein the first device is caused to:
receive, from the third device, sidelink control information indicating at least one of:
sidelink positioning reference signal resource identity information for a previous sidelink positioning reference signal,
a timestamp for the previous sidelink positioning reference signal, or
transmitting antenna reference point information for the previous sidelink positioning reference signal.

8. The first device of claim 1, wherein the first device is caused to:
determine the plurality of sidelink positioning reference signals is transmitted by the third device using at least one of: a same radio frequency chain, a same beam, a same transmission power, or a same antenna port, based on an association indicated by the sidelink control information.

9. The first device of claim 1, wherein the first device is caused to:
determine the number of the at least one sidelink positioning reference signal that is used for the sidelink positioning measurement.

10. The first device of claim 1, wherein the measurement report further comprises at least one of
a sidelink positioning type related to the sidelink positioning measurement,
identity information associated with the plurality of sidelink positioning reference signal resource,
antenna reference point information associated with the plurality of sidelink positioning reference signal,
the actual number of the sidelink positioning measurement samples used to determine the sidelink positioning measurement, or
the number of the at least one sidelink positioning reference signal.

11. The first device of claim 1, wherein this first request further comprises a specific number of sidelink positioning measurement samples.

12. A second device, comprising:
at least one processor; and
at least one memory storing instructions that, when executed by the at least one processor, cause the second device to:
transmit, to a first device, a first request for a sidelink positioning measurement that is based on a plurality of sidelink positioning measurement samples or a plurality of sidelink positioning reference signal resources; and
receive, from the first device, a measurement report indicating the sidelink positioning measurement.

13. The second device of claim 12, wherein the second device is caused to:
transmit, to the first device, a third request for a set of sidelink positioning measurements associated with a set of receiving antenna reference points at the first device and receive, from the first device, the measurement report comprising the set of sidelink positioning measurements; and/or
transmit, to the first device, a fourth request for a set of sidelink positioning measurements for a target receiving antenna reference point at the first device and receive, from the first device, the measurement report comprising the set of sidelink positioning measurements.

14. The second device of claim 12, wherein the measurement report further comprises at least one of
a sidelink positioning type related to the sidelink positioning measurement,
identity information associated with the plurality of sidelink positioning reference signal resource,
antenna reference point information associated with the plurality of sidelink positioning reference signals,
the actual number of the sidelink positioning measurement samples used to determine the sidelink positioning measurement, or
the number of the at least one sidelink positioning reference signal.

15. The second device of claim 12, wherein the second device is caused to at least one of:
determine an estimation of location of a target device based at least on the sidelink positioning measurement, wherein the target device is the first device or the third device;
transmit, to the first device, a sixth request that indicates the first device to obtain the specific number of sidelink positioning measurement samples; or
receive, from the third device, information indicating at least one of:
transmitting antenna reference point information for the plurality of sidelink positioning reference signals, or location information of a transmitting antenna reference point for the plurality of sidelink positioning reference signal.

16. The second device of claim 12, wherein the first request further comprises a specific number of sidelink positioning measurement samples.

17. A third device, comprising:
at least one processor; and
at least one memory storing instructions that, when executed by the at least one processor, cause the third device to:
receive, from a first device, a second request for a plurality of sidelink positioning reference signals transmitted on a plurality of sidelink positioning reference signal resources that is used to combine a plurality of sidelink positioning measurement samples; and
transmit, to the first device, the plurality of sidelink positioning reference signals through the plurality of sidelink positioning reference signal resources.

18. The third device of claim 17, wherein the third device is caused to at least one of:
receive, from the first device, a fifth request that indicating a target transmitting antenna reference point or a set of transmitting antenna reference points for the plurality of sidelink positioning reference signals at the third device; or
transmit, to the first device, sidelink control information indicating that a sidelink positioning reference signal scheduled by the sidelink control information is associated with a previous sidelink positioning reference signal resource and a transmitting antenna reference point.

19. The third device of claim 17, wherein the third device is caused to:
transmit, to the first device, sidelink control information indicating at least one of:
sidelink positioning reference signal resource identity information for a previous sidelink positioning reference signal,
a timestamp for the previous sidelink positioning reference signal, or
transmitting antenna reference point information for the previous sidelink positioning reference signal.

20. The third device of claim 17, wherein the third device is caused to:
transmit, to the first device, information indicating at least one of:
transmitting antenna reference point information for the plurality of sidelink positioning reference signal, or
location information of a transmitting antenna reference point for the plurality of sidelink positioning reference signal.
